(19) United States
(12) Patent Application Publication
(10) Pub. No.: US 2015/0296772 A1
(43) Pub. Date: Oct. 22, 2015

(54) METHODS OF USING TANKMIX ADDITIVE CONCENTRATES CONTAINING PARAFFINIC OILS

(71) Applicant: Dow AgroSciences LLC, Indianapolis, IN (US)

(72) Inventors: Melissa Gail Olds, Zionsville, IN (US); Hui Shao, Carmel, IN (US); Holger Tank, Zionsville, IN (US)

(73) Assignee: Dow AgroSciences LLC, Indianapolis, IN (US)

(21) Appl. No.: 14/688,732

(22) Filed: Apr. 16, 2015

Related U.S. Application Data
(60) Provisional application No. 61/980,907, filed on Apr. 17, 2014.
(60) Provisional application No. 61/980,887, filed on Apr. 17, 2014.

(51) Int. Cl. A01N 25/30; C08K 5/06; C08K 3/32; A01N 57/20

(52) U.S. Cl. CPC A01N 25/30; A01N 57/20; C08K 5/06; C08K 3/32; C08K 2003/321

(57) ABSTRACT

Tankmix additive concentrates containing a surfactant and a petroleum derived paraffinic oil and the use of aqueous pesticide spray mixtures incorporating such tankmix additive concentrates are described. The tankmix additive concentrates described herein include from 0.5 to 50 weight percent of a polymeric surfactant, a anionic ester surfactant, a nonionic surfactant, or mixtures thereof, and from 1 to 95 weight percent of a petroleum derived paraffinic oil. The tankmix additive concentrates form a stable emulsion upon dilution into a pesticide spray mixture.

This application claims a priority based on provisional application U.S. 61/980,887 and U.S. 61/980,907, which were filed in the U.S. Patent and Trademark Office on Apr. 17, 2014, the entire disclosure of which is hereby incorporated by reference.

### BACKGROUND

Economical, commercially available techniques for agricultural spraying typically include the use of hydraulic spray nozzles that inherently produce a wide spectrum of spray droplet sizes. The potential for these spray droplets to drift from the initial, desired site of application is a function of droplet size, with smaller droplets having a higher propensity for off-target movement. Although other factors such as meteorological conditions and spray boom height contribute to the potential for drift, spray droplet size distribution has been found to be a predominant factor. Teske et. al. (Teske M. E., Hewitt A. J., Valcore, D. L. 2004. The Role of Small Droplets in Classifying Drop Size Distributions ILASS Americas 17^{th} Annual Conference: Arlington Va.) have reported a value of <156 microns (μm) as the fraction of the spray droplet distribution that contributes to drift. Robert Wolf (Wolf, R. E., Keys to Spray Drift Management, Microsoft® PowerPoint Presentation (filename: Drift Minimization—2009), available at www.bae.ksu.edu/faculty/wolf/PowerPoint.htm, last viewed Oct. 8, 2013) cites a value of <200 μm as the driftable fraction.

The negative consequences of off-target movement can be quite pronounced. Some herbicides have demonstrated very sensitive phytotoxicity to particular plant species at extremely low parts per million (ppm) or even parts per billion (ppb) levels, resulting in restricted applications around sensitive crops, orchards, and residential plantings. For example, the California Dept of Pesticide Regulation imposes buffers of ½-2 miles for propanil containing herbicides applied aerially in the San Joaquin valley.

Significant research efforts, involving numerous field trials, wind tunnel tests and subsequent generation of predictive math models, have led to a better understanding of the relationship between spray droplet size and the potential for off-target drift. Based on this work, it has been found that a good estimation of droplet size likely to contribute to drift is the fraction of spray droplets having a diameter less than about 150 μm.

The use of excipients and carriers have been investigated as a means for reducing drift. WO/2013/142263 describes the use of vegetable oils as an excipient/carrier for reducing drift. However, the use of vegetable or seeds oils can raise the freezing point of herbicide formulations. For example, an aqueous solution of 2,4-D choline freezes at about −20° C. The addition of a vegetable or seed oil, such as canola oil, palm oil, sunflower oil, etc.) raise the freezing point to −10° C. The raising of the freezing point can affect the performance of the herbicidal composition, particularly when stored at low temperatures before use.

### SUMMARY

The methods described herein include the use of tankmix additive concentrates containing a surfactant and a petroleum derived paraffinic oil to reduce spray drift. The tankmix additive concentrates used with the methods described herein include from 0.5 to 50 weight percent of a surfactant, wherein the surfactant is a polymeric surfactant, a nonionic surfactant, a anionic surfactant, or mixtures thereof, and from 1 to 95 weight percent of a petroleum derived paraffinic oil. In the methods, the tankmix additive concentrate is added to a pesticide spray mixture and upon addition forms a stable emulsion in the pesticide spray mixture.

### DETAILED DESCRIPTION

Methods of using tankmix additive concentrate compositions to reduce spray drift are described herein. The methods reduce the amount of driftable fines of spray solutions in both aerial and ground spray applications. The methods include the use of tankmix additive concentrates incorporating a surfactant, selected from a polymeric surfactant, a anionic surfactant and a nonionic surfactant, or mixtures thereof, and a petroleum derived paraffinic oil.

The tankmix additive concentrates as used in the methods described herein include from 0.5 to 50 weight percent of a surfactant, selected from a polymeric surfactant, a anionic surfactant and a nonionic surfactant, or mixtures thereof, and from 1 to 95 weight percent of a petroleum derived paraffinic oil. The tankmix additive concentrates described herein form a stable emulsion upon dilution into a pesticide spray mixture.

The tankmix additive concentrates can be used in spray mixtures containing a pesticide and/or crop protection agent including herbicides, herbicide safeners, fungicides and insecticides. The pesticide or crop protection agent may be in the form of a water soluble derivative such as, for example, a water soluble salt. In some embodiments, the water-soluble salt is a water-soluble salt of one or more auxinic herbicides.

The concentrate is typically diluted with water to form a stable emulsion. The concentrate and/or water to which the concentrate is added can contain one or more additional additives, such as emulsifiers, antifoam agents, preservatives, antioxidants, colorants, and inert filling materials.

### I. Definitions

As used herein tankmix additive concentrate compositions are solutions containing a surfactant dissolved in a petroleum derived paraffinic oil. Such compositions, when added to an aqueous pesticide spray mixture, form a stable emulsion that upon spray application lead to a reduction in the amount of driftable fines.

As used herein, petroleum derived paraffinic oils refers to liquids, oils, and/or waxes derived from petroleum or petroleum derivatives.

### II. Method of Use

A. Tankmix Additive Concentrates

The tankmix additive concentrates as used in the methods described herein include from about 0.5 to about 50 weight percent of a surfactant, selected from a polymeric surfactant, a anionic surfactant and a nonionic surfactant, or mixtures thereof, and from about 1 to about 95 weight percent of a petroleum derived paraffinic oil. The tankmix additive concentrates form a stable emulsion upon dilution into a pesticide spray mixture.

The tankmix additive concentrates can be stored in suitable containers as will be readily recognized by one of skill in the art and can be, for example, solutions or emulsions.

The tankmix additive concentrates may optionally contain one or more additional compatible ingredients. Also, any other additional ingredients providing functional utility such as, for example, biocides, dyes, stabilizers, fragrants, viscosity-lowering additives, emulsifiers, colorants, preservatives, antifoaming agents, antioxidants, inert fillers, compatibility agents, organic co-solvents such as, for example, propylene glycol, propylene glycol ethers, dipropylene glycol ethers, ethylene glycol ethers and/or diethylene glycol ethers, and freeze-point depressants may be included in these tankmix additive concentrates. The use of organic co-solvents in the concentrates and spray solutions described herein may provide freezing-point depression and/or enhanced emulsion stability to these compositions.

B. Surfactants

The compositions described herein contain one or more surfactants. The surfactants may be polymeric surfactants, anionic surfactants, nonionic surfactants, or mixtures thereof. Examples of suitable polymeric surfactants include, but are not limited to, ABA block copolymers; polyvinyl alcohol resins; block or graft acrylate or methacrylate copolymers; alkyd polyethylene oxide resins; AB block copolymers containing EO and PO blocks such as ethylene oxide-propylene oxide (EO-PO) block copolymers; and mixtures thereof. Examples of suitable anionic surfactants include, but are not limited to, salts of alkylbenzenesulfonates; phosphate surfactants such as acids or salts of mono and dialkyl phosphate esters; acids or salts of ethoxylated mono and dialkyl phosphate esters; acids or salts of mono and dialkyl phosphate esters of ethoxylated tristyrylphenol; acids or salts of mono and dialkyl phosphate esters of ethoxylated phenol and ethoxylated alkylphenols; and mixtures thereof. Examples of suitable nonionic surfactants include, but are not limited to, alcohol alkoxylates; fatty alcohol alkoxylates; ethoxylated castor oils; sorbitan esters; ethoxylated sorbitan esters; ethoxylated sorbitol esters; ethoxylated tristyrylphenols; and mixtures thereof.

Examples of suitable polymeric surfactants include, but are not limited to, (1) ABA block copolymers having a hydrophilic portion of polyethylene oxide and a hydrophobic portion of poly(12-hydroxystearate) and having a molecular weight of about 5,000, such as, but are not limited to, Atlox™ 4912 (Croda; Edison, N.J.), and Termul™ 2510 (Huntsman International LLC; The Woodlands, Tex.); (2) polyvinyl alcohol resins with a degree of hydrolysis of 86-89%, such as, but are not limited to, Gohsenol GLO3 and Gohsenol GLO5 (The Nippon Synthetic Chemical Industry Co., Ltd.; Osaka, Japan); (3) methyl methacrylate graft copolymers, such as, but are not limited to, Atlox™ 4913 (Croda; Edison, N.J.); (4) alkyd polyethylene oxide resins, such as, but are not limited to, Atlox™ 4914 (Croda; Edison, N.J.) and the like; (5) EO-PO block copolymers, such as, but are not limited to, Atlas™ G-5000 (Croda; Edison, N.J.), and the Pluronic® block copolymers (BASF; Florham Park, N.J.), and the like. Especially suitable polymeric surfactants include the ABA block copolymers.

Examples of suitable anionic surfactants that are phosphate surfactants include, but are not limited to, Atlox™ DP13/6, Cresplus™ 1209, Crodafos™ 810A, Crodafos™ 810 D, Crodafos™ COSA, Crodafos™ CS2A, Crodafos™ D4A, Crodafos™ G26A, Crodafos™ O10A, Crodafos™ 010D SS, Crodafos™ 03A, Multitrope 1214, Crodafos™ TSA, and Crodafos™ T6A (all from Croda; Edison, N.J.); Cedephos FA-600, Petrostep® PE-70T, Polystep® P-12A, Polystep® P-33, Polystep® TSP-16PE, Stepan® MWA-311, Stepfac 8170, Stepfac 8171, Stepfac 8173, Stepfac 8175, Stepfac 8180, Stepfac 8181, Stepfac TSP-PE, Stepfac TSP-PE-K, Stepfac TSP-PE-N, Zelec® AN and Zelec® LA-2 (all from Stepan; Northfield, Ill.); Klearfac® AA 270, Maphos® 58, Maphos® 60 A, Maphos® 66 H, Maphos® M 60, Agnique® PE 2EH-2k, Agnique® PE NP-4, Agnique® PE NP-6, Agnique® PE NP-9, Agnique® PE DNP-8, Agnique® PE IDA-6, Agnique® PE TDA-6, Agnique® PE 25, Agnique® PE 28, Agnique® PE 28-9N and Agnique® PE 68-5 (all from BASF; Florham Park, N.J.); Duraphos 100, Duraphos 178, Lubrhophos LB 400, Lubrhophos LB/400-E, Lubrhophos LP/700 E, Lubrhophos RD/510-E, Rhodafac® AAP, Rhodafac® BN-936/S, Rhodafac® HA70, Rhodafac® LO-11/ALA, Rhodafac® LO/529-E, Rhodafac® PA 15, Rhodafac® PA 23, Rhodafac® PA 35, Rhodafac® PA/32, Rhodafac® PE 510, Rhodafac® RM 710, Rhodafac® RM/510-E, Rhodafac® RS 410, Rhodafac® RS 610-E, Rhodafac® RS 710, Rhodafac® RS-610/A25, Rhodafac® RS/710-E, Soprophor® 3 D 33, Trimethyl Phosphite HP and Trimethyl Phosphite (all from Rhodia; Cranberry, N.J.), and the SURFONIC® PE series and the EMPIPHOS® series (both from Huntsman International LLC; The Woodlands, Tex.).

Examples of suitable anionic surfactants that are salts of alkylbenzenesulfonates include, but are not limited to, Ninate® 411, Bio-Soft® N-411, Bio-Soft® 411-E, Bio-Soft® D-40, Bio-Soft® D-62-L, Bio-Soft® N-300, Ninate® 60E, Ninate® 60L, Ninate® 70B, and Ninate® 401-A (all from Stepan; Northfield, Ill.); Nansa® EVM 50/NS, Nansa® EVM 62/H, Nansa® EVM 62/N, Nansa® EVM 62/S, Nansa® EVM 63/B, Nansa® EVM 70/B, Nansa® EVM 70/13, Nansa® EVM 70/2E, Nansa® YS 94, Nansa® TS 50/F, and Nansa® AS/1 (all from Huntsman International LLC; The Woodlands, Tex.); Calsogen® EH, Calsogen® 4814, Phenylsulfonat CA, Phenylsulfonat CA 62, and Phenylsulfonat CAL (all from Clariant; Charlotte, N.C.).

Examples of suitable nonionic surfactants include, but are not limited to, (1) alcohol and fatty alcohol alkoxylates, such as Termul™ 5429 (from Huntsman International LLC; The Woodlands, Tex.); Tergitol™ 15-S-3, Tergitol™ 15-S-7, Tergitol™ 15-S-9, Tergitol™ 15-S-12, Tergitol™ 15-S-15, Tergitol™ 15-S-20, Tergitol™ 15-S-30, and Tergitol™ 15-S-40 (all from The Dow Chemical Co.; Midland, Mich.); Emulsogen® M-A, Genapol® C 050, Genapol® C 070, Genapol® C 100, Genapol® C 120, Genapol® C 200, Genapol® C 250, Genapol® LA 030, Genapol® LA 040, Genapol® LA 070, Genapol® LA 080, Genapol® LA 100, Genapol® LA 230, Genapol® LA 230, Genapol® O 050, Genapol® O 080, Genapol® O 100, Genapol® O 100, Genapol® O 120, Genapol® O 150, Genapol® O 200, Genapol® OX 050, Genapol® OX 070, Genapol® OX 080, Genapol® OX 100, Genapol® UD 070, Genapol® UD 79, Genapol® UD 080, Genapol® UD 110, Genapol® X030, Genapol® X 050, Genapol® X 060, Genapol® X 080, Genapol® X090, Genapol® X100, and Genapol® X 150 (all from Clariant; Charlotte, N.C.); Synperonic™ 10/6, Synperonic™ 13/3, Synperonic™ 13/5, Synperonic™ 13/6, Synperonic™ 13/6.5, Synperonic™ 13/8, Syperonic™ 13/9, Syperonic™ 13/10, Syperonic™ 13/12, Syperonic™ 91/2.5, Syperonic™ 91/5, Syperonic™ 91/6, Syperonic™ 91/8, Syperonic™ 91/10, Syperonic™ A2, Syperonic™ A3, Syperonic™ A4, Syperonic™ A7, Syperonic™ A7, Syperonic™ All, Syperonic™ A20, Syperonic™ AB6, and Syperonic™ AB8-90 (all from Croda; Edison, N.J.); Makon® DA-4, Makon® DA-6, Makon® DA-9, Makon® TD-3, Makon® TD-6, Makon® TD-12, Makon® TD-18, and Makon® TD-50 (all from Stepan; Northfield, Ill.); (2) ethoxylated castor oils, such as Etocas 5, Etocas 10, Etocas 29, Etocas 32, Etocas 35, and Etocas 40 (all from Croda; Edison, N.J.); Toximul 8240, Toximul 8241, and Toximul 8242 (all from Stepan; Northfield, Ill.); Termul®1283, Termul® 1284, Termul® 1285, Termul® 2507, Termul® 3512, and Termul® 3540 (all from Huntsman International LLC; The Woodlands, Tex.); Emulsogen® EL200, Emulsogen® EL300, Emulsogen® EL360, Emulsogen® EL 400, and Emulsogen® EL 540 (all from Clariant; Charlotte, N.C.); (3) sorbitan esters, such as Span™ 20, Span™ 40, Span™ 60, Span™ 65, Span™ 80, and Span™ 85 (all from Croda; Edison, N.J.); (4) ethoxylated sorbitan esters, such as Tween™ 20, Tween™ 21, Tween™ 40, Tween™ 60, Tween™ 61, Tween™ 65, Tween™ 80, Tween™ 81, and Tween™ 85 (all from Croda; Edison, N.J.); (5) ethoxylated sorbitol esters, such as Arlatone™ TV, Atlas™ G 1086, Atlas™ G-1096, Atlox™ 1045A, Cirrasol™ G-1086, and Cirrasol™ G-1096 (all from Croda; Edison, N.J.); Toximul® SEE-340, and Toximul® SEE-341 (from Stepan; Northfield, Ill.); and (6) ethoxylated tristyrylphenols, such as Emulsogen® TS 100, Emulsogen® TS 160, Emulsogen® TS 200, Emulsogen® TS 290, Emulsogen® TS 400, Emulsogen® TS 540, and Emulsogen® TS 600 (all from Clariant; Charlotte, N.C.); Tersperse® 2201, Tersperse® 2202, Tersperse® 2203, Tersperse® 2218, Tersperse® 2219, and Tersperse® 2222 (all from Huntsman International LLC; The Woodlands, Tex.); Makon® TSP-16, Makon® TSP-20, Makon® TSP-25, Makon® TSP-40, and Makon® TSP-60 (all from Stepan; Northfield, Ill.).

The tankmix additive concentrates used in the methods described herein include from 0.5 to 50 weight percent of a surfactant. Additional examples of concentrations for the surfactant in the concentrates described herein include, from 0.5 to 40 weight percent of the concentrate mixture, from 5 to 40 weight percent of the concentrate mixture, from 5 to 30 weight percent of the concentrate mixture, from 5 to 25 weight percent of the concentrate mixture, from 10 to 25 weight percent of the concentrate mixture, and from 10 to 20 weight percent of the concentrate mixture. Further examples of concentrations for the surfactant incorporated into the tankmix additive concentrates described herein include, from 8 to 22 weight percent of the concentrate mixture, from 9 to 21 weight percent of the concentrate mixture, from 11 to 19 weight percent of the concentrate mixture, from 12 to 18 weight percent of the concentrate mixture, from 13 to 17 weight percent of the concentrate mixture, from 14 to 16 weight percent of the concentrate mixture, from 10 to 18 weight percent of the concentrate mixture, from 10 to 16 weight percent of the concentrate mixture, from 10 to 14 weight percent of the concentrate mixture, from 10 to 12 weight percent of the concentrate mixture, from 12 to 20 weight percent of the concentrate mixture, from 14 to 20 weight percent of the concentrate mixture, from 16 to 20 weight percent of the concentrate mixture, and from 18 to 10 weight percent of the concentrate mixture.

C. Petroleum-Derived Paraffinic Oils

The composition contains one or more petroleum-derived paraffinic oils. In some embodiments, the oil is a saturated hydrocarbon or hydrocarbons. The saturated hydrocarbon or hydrocarbons may contain small amounts of aromatic hydrocarbons, for example less than 8%, particularly less than 4%. Suitable petroleum derived paraffinic oils include, but are not limited to, one or more of petroleum fractions or hydrocarbons such as mineral oil (e.g., open-chain (straight-chain or branched) C₁₄-C₃₀ hydrocarbons, cyclic hydrocarbons (naphthenes), and aromatic hydrocarbons), kerosene, paraffinic oils including normal paraffins (e.g., straight chain and branched C₁₄-C₃₀ hydrocarbons known as base oil or white oil and commercially available, for example, as BAYOU) 85 (Exxon Mobil), MARCOL® 82 (Exxon Mobil), BAR 0020 (RA.M.oil S.p.A.), Pionier 0032-20 (Hansen &Rosenthal KG), and Kristol M14), isoparaffins, cycloparaffins, highly refined paraffinic mineral oils, solvent dewaxed light and heavy paraffinic distillates and the like, and mixtures thereof. Examples of commercially available petroleum derived paraffinic oils useful in the methods and compositions described herein include: Sunspray® 6N and 11N which are available from HollyFrontier (Tulsa, Okla.). In some embodiments, the composition does not contain seed or vegetable oils.

The tankmix additive concentrates used in the methods described herein include from from 1 to 95 weight percent of a petroleum derived paraffinic oil. Additional examples of concentrations for the petroleum derived paraffinic oil incorporated into the tankmix additive concentrates described herein include, from 1 to 85 weight percent of the concentrate mixture, from 1 to 75 weight percent of the concentrate mixture, from 1 to 65 weight percent of the concentrate mixture, from 1 to 55 weight percent of the concentrate mixture, from 1 to 45 weight percent of the concentrate mixture, from 1 to 35 weight percent of the concentrate mixture, from 1 to 30 weight percent of the concentrate mixture, from 1 to 25 weight percent of the concentrate mixture, from 1 to 20 weight percent of the concentrate mixture, from 1 to 15 weight percent of the concentrate mixture, from 1 to 10 weight percent of the concentrate mixture, from 5 to 20 weight percent of the concentrate mixture, and from 10 to 20 weight percent of the concentrate mixture. Further examples of concentrations for the petroleum derived paraffinic oil incorporated into the tankmix additive concentrates described herein include, from 5 to 80 weight percent of the concentrate mixture, from 10 to 80 weight percent of the concentrate mixture, from 10 to 70 weight percent of the concentrate mixture, from 10 to 60 weight percent of the concentrate mixture, from 10 to 50 weight percent of the concentrate mixture, from 10 to 40 weight percent of the concentrate mixture, from 10 to 30 weight percent of the concentrate mixture, from 10 to 25 weight percent of the concentrate mixture, from 5 to 40 weight percent of the concentrate mixture, from 5 to 30 weight percent of the concentrate mixture, from 5 to 25 weight percent of the concentrate mixture, from 10 to 25 weight percent of the concentrate mixture, and from 10 to 20 weight percent of the concentrate mixture. More examples of concentrations for the petroleum derived paraffinic oil incorporated into the tankmix additive concentrates described herein include, from 8 to 22 weight percent of the concentrate mixture, from 9 to 21 weight percent of the concentrate mixture, from 11 to 19 weight percent of the concentrate mixture, from 12 to 18 weight percent of the concentrate mixture, from 13 to 17 weight percent of the concentrate mixture, from 14 to 16 weight percent of the concentrate mixture, from 10 to 18 weight percent of the concentrate mixture, from 10 to 16 weight percent of the concentrate mixture, from 10 to 14 weight percent of the concentrate mixture, from 10 to 12 weight percent of the concentrate mixture, from 12 to 20 weight percent of the concentrate mixture, from 14 to 20 weight percent of the concentrate mixture, from 16 to 20 weight percent of the concentrate mixture, and from 18 to 10 weight percent of the concentrate mixture.

The weight percent ratio of the surfactant to the petroleum derived paraffinic oil used in the tankmix additive concentrates described herein can range from 50:1 to 1:90. Additional examples of weight percent ratio ranges of surfactant to petroleum derived paraffinic oil in the tankmix additive concentrates described herein include, from 40:1 to 1:80, from 30:1 to 1:70, from 20:1 to 1:60, from 10:1 to 1:50, from 10:1 to 1:40, from 10:1 to 1:30, from 20:1 to 1:60, from 10:1 to 1:50, from 10:1 to 1:40, from 10:1 to 1:30, from 10:1 to 1:20, from 10:1 to 1:10, from 5:1 to 1:5, from 4:1 to 1:4, from 3:1 to 1:3, from 2:1 to 1:2, from 2:1 to 1:1, and from 1:1 to 1:2. Examples of weight percent ratios of surfactant to petroleum derived paraffinic oil in the tankmix additive concentrates described herein include, 50:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:70, 1:80, and 1:90.

D. Pesticides and Crop Protection Agents

The methods described herein are useful with pesticide spray mixtures containing pesticides and other ingredients such as herbicides, insecticides, herbicide safeners, and/or fungicides. The pesticide spray mixtures disclosed herein may be applied for the control of unwanted plants, fungi, or insects at levels dependent on the concentration of the active ingredient needed to control the target pest.

1. Herbicides

Herbicides that are suitable for use with the tankmix additive concentrates described herein include, but are not limited to, one or more of 4-CPA, 4-CPB, 4-CPP, 2,4-D, 3,4-DA, 2,4-DB, 3,4-DB, 2,4-DEB, 2,4-DEP, 3,4-DP, 2,4,5-T, 2,4,5-TB, 2,3,6-TBA, allidochlor, acetochlor, acifluorfen, aclonifen, alachlor, alloxydim, alorac, ametridione, ametryn, amibuzin, amicarbazone, amidosulfuron, aminocyclopyrachlor, aminopyralid, aminopyralid, amiprofos-methyl, amitrole, anilofos, anisuron, asulam, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicylopyrone, bifenox, bilanafos, bilanafos, bispyribac, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cafenstrole, cafenstrole, cambendichlor, carbasulam, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, clomeprop, cloprop, cloproxydim, clopyralid, clopyralid, cloransulam, CPMF, CPPC, credazine, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinitramine, dinofenate, dinoprop, dinosam, dinoseb, dinoterb, diphenamid, dipropetryn, diquat, disul, dithiopyr, diuron, DMPA, DNOC, EBEP, eglinazine, endothal, epronaz, epronaz, EPTC, erbon, esprocarb, ethalfluralin, ethametsulfuron, ethidimuron, ethiolate, ethofumesate, ethoxyfen, ethoxysulfuron, etinofen, etnipromid, etnipromid, etnipromid, etobenzanid, EXD, fenasulam, fenasulam, fenasulam, fenoprop, fenoxaprop, fenoxaprop-P, fenoxasulfone, fenteracol, fenthiaprop, fentrazamide, fenuron, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupoxam, flupropacil, flupropanate, flupyrsulfuron, fluridone, flurochloridone, fluroxypyr, flurtamone, fluthiacet, fomesafen, fomesafen, foramsulfuron, fosamine, furyloxyfen, glufosinate, glyphosate, halauxifen, halosafen, halosafen, halosulfuron, haloxydine, haloxyfop, haloxyfop-P, hexazinone, imazamethabenz, imazamox, imazapic, imazapyr, imazaquin, imazethapyr, imazosulfuron, indanofan, indaziflam, iodobonil, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MCPA, MCPA-thioethyl, MCPB, mecoprop, mecoprop-P, medinoterb, mefenacet, mefluidide, mesoprazine, mesosulfuron, mesotrione, metam, metamifop, metamifop, metamitron, metazachlor, metazosulfuron, metflurazon, methabenzthiazuron, methalpropalin, methazole, methiobencarb, methiozolin, methiuron, methiuron, methometon, methoprotryne, methyldymron, metobenzuron, metobromuron, metolachlor, S-metolachlor, metosulam, metoxuron, metribuzin, metsulfuron, molinate, monalide, monisouron, monochloroacetic acid, monolinuron, monuron, morfamquat, naproanilide, napropamide, naptalam, neburon, nicosulfuron, nipyraclofen, nitralin, nitrofen, nitrofluorfen, norflurazon, noruron, OCH, orbencarb, orthosulfamuron, oryzalin, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentanochlor, pentoxazone, perfluidone, pethoxamid, phenisopham, phenmedipham, phenmedipham-ethyl, phenobenzuron, picloram, picloram, picolinafen, picolinafen, pinoxaden, piperophos, pretilachlor, primisulfuron, procyazine, prodiamine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, sebuthylazine, secbumeton, sethoxydim, siduron, simazine, simeton, simetryn, sulcotrione, sulfallate, sulfentrazone, sulfometuron, sulfosulfuron, sulglycapin, swep, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr and triclopyr, thidiazimin, thidiazuron, thidiazuron, thiencarbazone-methyl, thifensulfuron, thiobencarb, tiocarbazil, tioclorim, topramezone, tralkoxydim, tri-allate, triasulfuron, triaziflam, tribenuron, tricamba, tridiphane, trietazine, trifloxysulfuron, trifluralin, triflusulfuron, trifop, trifopsime, trihydroxytriazine, trimeturon, tripropindan, tritac, tritosulfuron, vemolate, xylachlor, and compounds of the following Formula

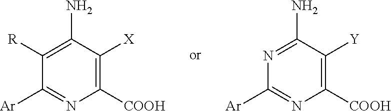

wherein Ar represents a phenyl group substituted with one to four substituents independently selected from halogen, C₁-C₆ alkyl, C₁-C₆ alkoxy, C₂-C₄ alkoxyalkyl, C₂-C₆ alkylcarbonyl, C₁-C₆ alkylthio, C₁-C₆ haloalkyl, C₁-C₆ haloalkoxy, C₂-C₄ haloalkoxyalkyl, C₂-C₆ haloalkylcarbonyl, C₁-C₆ haloalkylthio, —OCH₂CH₂—, —OCH₂CH₂CH₂—, —OCH₂O— or —OCH₂CH₂O—; R represents H or F; X represents Cl or vinyl; and Y represents Cl, vinyl or methoxy; and their salts and esters as disclosed, for example, in U.S. Pat. No. 7,314,849 B2, U.S. Pat. No. 7,300,907 B2, U.S. Pat. No. 7,786,044 B2 and U.S. Pat. No. 7,642,220 B2.

Especially suitable herbicides useful with the tankmix additive concentrates described herein include auxinic herbicides such as 2,4-D, 2,4-DB, aminocyclopyrachlor, aminopyralid, clopyralid, dicamba, fluroxypyr, halauxifen, MCPA, MCPB, picloram and triclopyr, and acetochlor, atrazine, benfluralin, cloransulam, cyhalofop, diclosulam, dithiopyr, ethalfluralin, florasulam, flumetsulam, glufosinate, glyphosate, haloxyfop, isoxaben, MSMA, oryzalin, oxyfluorfen, pendimethalin, penoxsulam, propanil, pyroxsulam, quizalofop, tebuthiuron, trifluralin, and the compound of the Formula

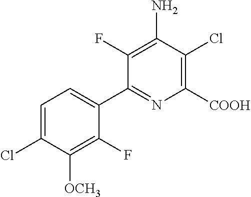 [SMILES: COc1c(Cl)ccc(-c2nc(C(=O)O)c(Cl)c(N)c2F)c1F]

and its C₁-C₁₂ alkyl or C₇-C₁₂ arylalkyl ester or salt derivatives such as, for example, the benzyl ester.

Especially suitable herbicides useful with the tankmix additive concentrates described herein include auxinic herbicides such as, for example, clopyralid, triclopyr, 2,4-D, 2,4-DB, MCPA, MCPB, aminocyclopyrachlor, dicamba, aminopyralid, picloram, or mixtures thereof. Pesticide spray mixtures containing the tankmix additive concentrates described herein are particularly useful for the application of herbicides that are subject to restricted applications around sensitive crops such as spray mixtures containing glyphosate, 2,4-D, triclopyr, dicamba, or mixtures thereof.

2. Insecticides

Insecticides that are suitable for use with the tankmix additive concentrates described herein include, but are not limited to, one or more of abamectin, acephate, acetamiprid, acethion, acetoprole, acrinathrin, alanycarb, aldicarb, aldoxycarb, allethrin, allosamidin, allyxycarb, amidithion, aminocarb, amiton, amitraz, anabasine, athidathion, azadirachtin, azamethiphos, azinphos-ethyl, azinphos-methyl, azothoate, barthrin, bendiocarb, benfuracarb, bensultap, bifenthrin, bioallethrin, bioethanomethrin, biopermethrin, bioresmethrin, bistrifluron, bromfenvinfos, bromophos, bromophos-ethyl, bufencarb, buprofezin, butacarb, butathiofos, butocarboxim, butonate, butoxycarboxim, cadusafos, carbanolate, carbaryl, carbofuran, carbophenothion, carbosulfan, cartap, chlorantraniliprole (rynaxypyr), chlordimeform, chlorethoxyfos, chlorfenapyr, chlorfenvinphos, chlorfluazuron, chlormephos, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, coumaphos, coumithoate, crotamiton, crotoxyphos, crufomate, cyanofenphos, cyanophos, cyanthoate, cyantranilipole, cyazypyr, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, cyromazine, cythioate, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, dialifos, diazinon, dicapthon, dichlofenthion, dichlorvos, dicresyl, dicrotophos, dicyclanil, diflubenzuron, dimefluthrin, dimefox, dimethoate, dimethrin, dimethylvinphos, dimetilan, dimitan, dinex, dinoprop, dinosam, dinotefuran, diofenolan, dioxabenzofos, dioxacarb, dioxathion, disulfoton, dithicrofos, DNOC, doramectin, a-ecdysone, ecdysterone, emamectin, EMPC, empenthrin, endothion, EPN, epofenonane, eprinomectin, esfenvalerate, etaphos, ethiofencarb, ethion, ethiprole, ethoate-methyl, ethoprophos, etofenprox, etrimfos, EXD, famphur, fenamiphos, fenazaflor, fenazaquin, fenchlorphos, fenethacarb, fenfluthrin, fenitrothion, fenobucarb, fenoxacrim, fenoxycarb, fenpirithrin, fenpropathrin, fenpyroximate, fensulfothion, fenthion, fenthion-ethyl, fenvalerate, fipronil, flonicamid, flubendiamide, flubendiamide, flucofuron, flucycloxuron, flucythrinate, flufenerim, flufenoxuron, flufenprox, fluvalinate, tau-fluvalinate, fonofos, formetanate, formothion, formparanate, fosmethilan, fospirate, fosthietan, furathiocarb, furethrin, halfenprox, halofenozide, heptenophos, heterophos, hexaflumuron, hydramethylnon, hydroprene, hyquincarb, imicyafos, imidacloprid, imidacloprid, imiprothrin, indoxacarb, IPSP, isazofos, isocarbophos, isofenphos, isoprocarb, isoprothiolane, isothioate, isoxathion, ivermectin, jasmolin I, jasmolin II, jodfenphos, juvenile hormone I, juvenile hormone II, juvenile hormone III, kinoprene, lepimectin, leptophos, d-limonene, lirimfos, lufenuron, lythidathion, malathion, malonoben, mazidox, mecarbam, mecarphon, menazon, mephosfolan, mesulfenfos, metaflumizone, methacrifos, methamidophos, methidathion, methiocarb, methocrotophos, methomyl, methoprene, methoxyfenozide, metofluthrin, metolcarb, metoxadiazone, mevinphos, mexacarbate, milbemectin, milbemycin oxime, mipafox, monocrotophos, morphothion, moxidectin, naftalofos, naled, nicotine, nifluridide, nitenpyram, nitenpyram, nithiazine, nitrilacarb, novaluron, noviflumuron, omethoate, oxamyl, oxydemeton-methyl, oxydeprofos, oxydisulfoton, parathion, parathion-methyl, penfluron, permethrin, phenkapton, phenothrin, phenthoate, phorate, phosalone, phosfolan, phosmet, phosmet, phosnichlor, phosphamidon, phoxim, phoxim-methyl, pirimetaphos, pirimicarb, pirimiphos-ethyl, pirimiphos-methyl, prallethrin, precocene I, precocene II, precocene III, primidophos, profenofos, profluthrin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, sophamide, spinetoram, spinosad, 21-butenyl spinosyns, spirodiclofen, spiromesifen, spirotetramat, sulcofuron, sulfotep, sulfoxaflor, sulprofos, tazimcarb, tebufenozide, tebufenpyrad, tebupirimfos, teflubenzuron, tefluthrin, temephos, TEPP, terallethrin, terbufos, tetrachlorvinphos, tetramethrin, tetramethrin, thiacloprid, thiamethoxam, thicrofos, thiocarboxime, thiocyclam, thiodicarb, thiofanox, thiometon, thiosultap, thuringensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb and zolaprofos. Especially suitable insecticide active ingredients and derivatives thereof include chlorpyrifos, chlorpyrifos-methyl, clothianidin, cyazypyr, lambda-cyhalothrin, deltamethrin, dinotefuran, flonicamid, flubendiamide, imidacloprid, rynaxypyr, spinetoram, spinosad, 21-butenyl spinosyns, sulfoxaflor, and thiacloprid.

Especially suitable insecticides for use with the tankmix additive concentrates described herein include chlorpyrifos, chlorpyrifos—methyl, gamma-cyhalothrin, cypermethrin, deltamethrin, halofenozide, methoxyfenozide, sulfoxaflor, spinosad, spinetoram, and tebufenozide.

3. Fungicides

Fungicides that are suitable for use with the tankmix additive concentrates described herein include, but are not limited to, one or more of ametoctradin, amisulbrom, ampropylfos, anilazine, antimycin, azaconazole, azithiram, azoxystrobin, barium polysulfide, Bayer 32394, benalaxyl, benodanil, benomyl, benquinox, bentaluron, benthiavalicarb-isopropyl, benzamacril; benzamacril-isobutyl, benzamorf, benzylaminobenzene-sulfonate (BAB S) salt, binapacryl, biphenyl, bismerthiazol, bitertanol, bixafen, blasticidin-S, boscalid, bromuconazole, bupirimate, buthiobate, BYF 1047, captafol, captan, carbamorph, carbendazim, carboxin, carpropamid, carvone, CECA, chlobenthiazone, chloraniformethan, chlorfenazole, 1-chloro-2,4-dinitronaphthalene, chloroneb, chlorothalonil, chlorquinox, chlozolinate, climbazole, copper bis(3-phenylsalicylate), coumarin, cuprobam, cyazofamid, cyclafuramid, cyflufenamid, cymoxanil, cypendazole, cyproconazole, cyprodinil, cyprofuram, dazomet, debacarb, decafentin, diammonium ethylenebis (dithiocarb-amate), dichlofluanid, dichlone, dichloran, 3-(4-chlorophenyl)-5-methylrhodanine, dichlorophen, (RS)-N-(3,5-dichlorophenyl)-2-(methoxymethyl)-succinimide, N-3,5-dichlorophenylsuccinimide, 1,3-dichloro-1,1,3,3-tetrafluoroacetone hydrate, dichlozoline, diclobutrazol, diclocymet, diclomezine, diethofencarb, difenoconazole, difenzoquat ion, diflumetorim, dimethirimol, dimethomorph, dimoxystrobin, diniconazole, diniconazole-M, dinocap, dinocton, dinosulfon, dinoterbon, diphenylamine, dipyrithione, ditalimfos, dithianon, dodemorph, dodemorph acetate, dodicin, dodine, dodine free base, drazoxolon, EBP, edifenphos, enestrobin, epoxiconazole, ESBP, etaconazole, etem, ethaboxam, ethirim, ethoxyquin, N-ethylmercurio-4-toluenesulfonanilide, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluotrimazole, fluoxastrobin, fluquinconazole, flusilazole, flusulfamide, flutolanil, flutriafol, fluxapyrad, folpet, formaldehyde, fosetyl, fosetyl-aluminium, fuberidazole, furalaxyl, furametpyr, furcarbanil, furconazole, furconazole-cis, furmecyclox, furophanate, glyodine, griseofulvin, guazatine, guazatine acetates, GY-81, halacrinate, 2-(2-heptadecyl-2-imidazolin-1-yl)ethanol, Hercules 3944, hexaconazole, hexylthiofos, 8-hydroxyquinoline sulfate, hymexazol, ICIA0858, IK-1140, imazalil, imazalil sulfate, imibenconazole, iminoctadine, iminoctadine triacetate, iminoctadine tris(albesilate), ipconazole, iprobenfos, iprodione, iprovalicarb, isopamphos, isoprothiolane, isopyrazam, isotianil, isovaledione, kasugamycin, kasugamycin hydrochloride hydrate, kresoxim-methyl, mancopper, mancozeb, mandipropamid, maneb, mebenil, mecarbinzid, mefenoxam, mepanipyrim, mepronil, meptyl dinocap, meptyldinocap, metalaxyl, metazoxolon, metconazole, methasulfocarb, methfuroxam, methylmercury dicyandiamide, metiram, metominostrobin, metrafenone, metsulfovax, mildiomycin, milneb, mucochloric anhydride, myclobutanil, myclozolin, nabam, natamycin, nickel bis(dimethyldithiocarbamate), N-3-nitrophenylitaconimide, nitrothal-isopropyl, nuarimol, OCH, octhilinone, ofurace, orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, 2-phenylphenol, phosdiphen, phthalide, picoxystrobin, polyoxin B, polyoxins, polyoxorim, potassium hydroxyquinoline sulfate, probenazole, prochloraz, procymidone, propamocarb, propamocarb hydrochloride, propiconazole, propineb, proquinazid, prothiocarb, prothiocarb hydrochloride, prothioconazole, pyracarbolid, pyraclostrobin, pyraxostrobin, pyrazophos, pyribencarb, pyributicarb, pyridinitril, pyrifenox, pyrimethanil, pyriofenone, pyrometostrobin, pyroquilon, pyroxychlor, pyroxyfur, quinacetol; quinacetol sulfate, quinazamid, quinconazole, quinoclamine, quinoxyfen, quintozene, rabenzazole, Reynoutria sachalinensis extract, salicylanilide, sedaxane, silthiofam, simeconazole, sodium 2-phenylphenoxide, sodium pentachlorophenoxide, spiroxamine, SSF-109, sultropen, SYP-048, SYP-Z048, SYP-Z071, tebuconazole, tebufloquin, tecnazene, tecoram, tetraconazole, thiabendazole, thiadifluor, thicyofen, thifluzamide, thiochlorfenphim, 2-(thiocyanatomethylthio)-benzothiazole, thiophanate, thiophanate-methyl, thioquinox, thiram, tiadinil, tioxymid, tolclofos-methyl, tolylfluanid, triadimefon, triadimenol, triamiphos, triarimol, triazbutil, triazoxide, trichlamide, tricyclazole, tridemorph, trifloxystrobin, triflumizole, triforine, triticonazole, UK-2A, derivatives of UK-2A such as, for example, (3S,6S,7R,8R)-8-benzyl-3-(3-(isobutyryloxymethoxy)-4-methoxypicolinamido)-6-methyl-4,9-dioxo-1,5-dioxonan-7-yl isobutyrate which has a CAS Registry Number of 328255-92-1, urbacid, validamycin, valifenate, valiphenal, vinclozolin, XRD-563, zarilamid, zineb, ziram, and zoxamide.

Especially suitable fungicides useful with the tankmix additive concentrates described herein include azoxystrobin, bixafen, boscalid, carbendazim, carpropamid, chlorothalonil, derivatives of UK-2A, epoxiconazole, fenbuconazole, fenpropidin, fenpropimorph, fluoxastrobin, flusilazole, fluxapyrad, isopyrazam, isotianil, kasugamycin, mancozeb, meptyldinocap, metconazole, metrafenone, myclobutanil, orysastrobin, penconazole, pencycuron, penthiopyrad, picoxystrobin, probenazole, prochloraz, propiconazole, prothioconazole, pyraclostrobin, quinoxyfen, spiroxamine, tebuconazole, thifluzamide, triadimefon, tricyclazole, tridemorph, trifloxystrobin, and validamycin.

4. Herbicide Safeners

Herbicide safeners that are suitable for use with the tankmix additive concentrates described herein include, but are not limited to, one or more of benoxacor, benthiocarb, cloquintocet, daimuron, dichlormid, dicyclonon, dimepiperate, fenchlorazole, fenclorim, flurazole, fluxofenim, furilazole, Harpin proteins, isoxadifen, mefenpyr, mephenate, MG 191, MON 4660, naphthalic anhydride (NA), oxabetrinil, R29148, TI-35, and N-phenyl-sulfonylbenzoic acid amides.

Especially suitable herbicide safeners useful with the tankmix additive concentrates described herein include cloquintocet, flurazole, furilazole, isoxadifen, mefenpyr and TI-35.

### III. Pesticide Sprays

A. Pesticide Spray Mixtures

The methods described herein may include the application of one or more additional active ingredients to control a wide variety of unwanted plants, fungi, or insects. The tankmix additive concentrates as described herein may be diluted from 1 to 2000 fold in a pesticide spray mixture (e.g., a water based solution) at the point of use depending on the local agricultural practices and used in pesticide spray applications to control weeds, insects, or fungi in crop and non-crop environments.

In an example of a pesticide spray mixture containing an auxin herbicide and an additional herbicide used in the methods described herein, the auxinic herbicide is a water soluble salt of 2,4-D or a water soluble salt of dicamba and the additional herbicide is glyphosate or glufosinate. In another example of a pesticide spray mixture containing an auxinic herbicide and an additional herbicide used in the methods described herein, the auxinic herbicide is 2,4-D choline salt or 2,4-D dimethyl ammonium salt and the additional herbicide is glyphosate dimethyl ammonium salt, glyphosate isopropyl ammonium salt, or glyphosate potassium salt. In a further example of a pesticide spray mixture containing an auxinic herbicide and an additional herbicide used in the methods described herein, the auxinic herbicide is 2,4-D choline salt or 2,4-D dimethyl ammonium salt, the additional herbicide is glyphosate dimethyl ammonium salt, glyphosate isopropyl ammonium salt, or glyphosate potassium salt, and the petroleum derived paraffinic oil includes a normal paraffin, an isoparaffin, a cycloparaffin, a highly refined paraffinic mineral oil, a solvent dewaxed light or heavy paraffinic distillate and the like, or mixtures thereof. Examples of commercially available petroleum derived paraffinic oils useful in the methods and compositions described herein include Sunspray® 6N and 11N which are available from HollyFrontier (Tulsa, Okla.).

In an additional example of a pesticide spray mixture containing an auxinic herbicide and an additional herbicide used in the methods described herein, the auxinic herbicide is 2,4-D choline salt, the additional herbicide is glyphosate dimethyl ammonium salt, and the petroleum derived paraffinic oil includes a normal paraffin, an isoparaffin, a cycloparaffin, a highly refined paraffinic mineral oil, a solvent dewaxed light or heavy paraffinic distillate, and the like, or mixtures thereof. Examples of commercially available petroleum derived paraffinic oils useful in the methods and compositions described herein include, but are not limited to, Sunspray® 6N and 11N which are available from HollyFrontier (Tulsa, Okla.).

In an example of a pesticide spray mixture to which a tankmix additive concentrate as described herein has been added to be used in the methods described herein, the pesticide spray mixture contains a herbicide, the herbicide is an auxinic herbicide, and the auxinic herbicide is 2,4-D choline salt or 2,4-D dimethyl ammonium salt. In another example of a pesticide spray mixture to which a tankmix additive concentrate as described herein has been added, the pesticide spray mixture contains an auxinic herbicide, the auxinic herbicide is 2,4-D choline salt or 2,4-D dimethyl ammonium salt, and the petroleum derived paraffinic oil is a normal paraffin, an isoparaffin, a cycloparaffin, a highly refined paraffinic mineral oil, a solvent dewaxed light or heavy paraffinic distillate, and the like, or mixtures thereof. In a further example of a pesticide spray mixture to which a tankmix additive concentrate as described herein has been added, the pesticide spray mixture contains an auxinic herbicide, the auxinic herbicide is 2,4-D choline salt and the petroleum derived paraffinic oil is a normal paraffin, an isoparaffin, a cycloparaffin, a highly refined paraffinic mineral oil, a solvent dewaxed light or heavy paraffinic distillate, and the like, or mixtures thereof.

B. Spray Droplet Size

The optimum spray droplet size for a pesticide spray mixture when sprayed depends on the application for which the pesticide spray mixture is used. If droplets are too large, there will be less coverage by the spray; i.e, large droplets will land in certain areas while areas in between will receive little or no spray coverage. The maximum acceptable droplet size may depend on the amount of pesticide spray mixture being applied per unit area and the need for uniformity in spray coverage. Smaller droplets provide more even coverage, but are more prone to drift during spraying. Thus, application parameters such as uniformity in spray coverage must be balanced against the tendency for smaller droplets to drift. For example, if it is particularly windy during spraying, larger droplets may be needed to reduce drift, whereas on a calmer day smaller droplets may be acceptable.

In addition to the physical properties of a particular pesticide spray mixture, spray droplet size ay also depend on the spray apparatus, e.g., nozzle size and configuration. The reduction in spray drift may result from a variety of factors including a reduction in the production of fine spray droplets (<150 μm minimum diameter) and an increase in the volume median diameter (VMD) of the spray droplets. In any event, for a given spray apparatus, application, and conditions, and based on the petroleum derived paraffinic oil, the median diameter of the plurality of spray droplets created using the tankmix additive concentrates and methods described herein is increased above that of a pesticide spray mixture that does not include the petroleum derived paraffinic oil as described herein. In some embodiments, spray mixtures containing the concentrate have volume percentage of driftable fines having a diameter less than 150 microns from about 20% to about 35%, preferably from about 20% to about 30%, more preferably from about 20% to about 25%.

C. Spraying Near Sensitive or Susceptible Crops

The methods and compositions described herein are designed to be used in crops in which the particular pesticide used will not harm the crop or in situations where a crop is not present. The low drift properties of the compositions and the use of the compositions in the described methods also have benefits in relation to any sensitive or susceptible crops that are near the area upon which the composition is applied. For example, if the methods or compositions described herein are used with a pesticide-tolerant crop, the drift reduction will allow a non-tolerant crop to grow nearby without fear that any drift of a pesticide that would occur during the spray process with other non-low drift pesticide spray mixtures will deliver the pesticide to the nearby crop. As used herein, a sensitive or susceptible crop is one that is sensitive or susceptible to the herbicidal activity of the pesticide being applied, i.e., the pesticide kills, controls, or otherwise adversely modifies the growth of the nearby crop. Thus, the compositions and methods described herein can be used near sensitive or susceptible crops. For example, a composition as described herein including 2,4-D choline can be used on a 2,4-D tolerant crop with a non-2,4-D tolerant crop in a nearby field with minimal or no drift of the 2,4-D choline to the non-2,4-D tolerant crop. The actual distance of a nearby field can depend on the actual sensitivity of the nearby crop and can be varied depending on the sensitive or susceptible crop for planning purposes. For example, a nearby field can be 10 feet or more away, 15 feet or more away, 20 feet or more away, 25 feet or more away, 30 feet or more away, 35 feet or more away, 40 feet or more away, 45 feet or more away, 50 feet or more away, 55 feet or more away, 60 feet or more away, 65 feet or more away, 70 feet or more away, 75 feet or more away, 80 feet or more away, 85 feet or more away, 90 feet or more away, 95 feet or more away, or 100 feet or more away. Additionally, a nearby field can be 110 feet or more away, 120 feet or more away, 130 feet or more away, 140 feet or more away, 150 feet or more away, 160 feet or more away, 170 feet or more away, 180 feet or more away, 190 feet or more away, or 200 feet or more away. Further, a nearby field can be 225 feet or more away, 250 feet or more away, 275 feet or more away, 300 feet or more away, 325 feet or more away, 350 feet or more away, 375 feet or more away, 400 feet or more away, 425 feet or more away, 450 feet or more away, 475 feet or more away, 500 feet or more away, 525 feet or more away, 550 feet or more away, 575 feet or more away, 600 feet or more away, 625 feet or more away, 650 feet or more away, 675 feet or more away, 700 feet or more away, 725 feet or more away, 750 feet or more away, 775 feet or more away, 800 feet or more away, 825 feet or more away, 850 feet or more away, 875 feet or more away, 900 feet or more away, 925 feet or more away, 950 feet or more away, 975 feet or more away, or 1000 feet or more away.

The following Examples are presented to illustrate various aspects of the compositions and methods described herein and should not be construed as limitations to the claims.

### Example 1

### Paraffinic Oil Based Drift-Control Concentrate 1

A paraffinic oil based drift control concentrate containing 700 g/kg of paraffinic oil (Sunspray® 11N from Holly Frontier, Tulsa, Okla.), 25 g/kg of Emulsogen® M-A (Clariant; Charlotte, N.C.), 50 g/kg of Crodafos™ 010 D SS (Croda; Edison, N.J.), 6.0 g/kg of Adox™ 4912 (Croda; Edison, N.J.), and 219 g/kg of dipropylene glycol dimethyl ether were prepared as follows. An 8-oz vial was first charged with 70.1 g of Sunspray® 11N paraffinic oil. To the vial was added, 21.9 g of dipropylene glycol dimethyl ether, 0.62 g of Atlox™ 4912, 2.54 g of Emulsogen® M-A and finally 5.19 g of Crodafos™ 010 D SS. The mixture was mixed with an overhead agitator to provide 100 g of a homogenous sample of Drift-control Concentrate 1 (Table 1).

TABLE 1
Composition of Drift-control Concentrate 1

| Composition | Wt % |
|---|---|
| Sunspray ® 11N Paraffinic Oil | 70.0% |
| Emulsogen ® M-A | 2.5% |
| Crodafos ™ O10D SS | 5.0% |
| Atlox ™ 4912 | 0.6% |
| Dipropylene glycol dimethyl ether | 21.9% |

### Paraffinic Oil Based Drift-Control Concentrate 2

A paraffinic oil based drift control concentrate containing 700 g/kg of paraffinic oil (Sunspray® 11N), 25 g/kg of Tergitol™ 15-S-7 (The Dow Chemical Co., Midland, Mich.), 50 g/kg of Crodafos™ 010 D SS (Croda; Edison, N.J.), 6.0 g/kg of Atlox™ 4912 (Croda; Edison, N.J.), and 219 g/kg of dipropylene glycol dimethyl ether was prepared as follows. An 8-oz vial was first charged with 70.05 g of Sunspray® 11N paraffinic oil. To the vial was then added, 22.0 g of dipropylene glycol dimethyl ether, 0.63 g of Atlox™ 4912, 2.55 g of Tergitol™ 15-S-7 and finally 5.0 g of Crodafos™ 010 D SS. The mixture was mixed with overhead agitator to provide 100 g of a homogenous sample of Drift-control Concentrate 2 (Table 2).

TABLE 2
Composition of Drift-control Concentrate 2

| Composition | Wt % |
|---|---|
| Sunspray ® 11N paraffinic oil | 70.0% |
| Tergitol ™ 15-S-7 | 2.5% |
| Crodafos ™ O10D SS | 5.0% |
| Atlox ™ 4912 | 0.6% |
| Dipropylene glycol dimethyl ether | 21.9% |

### Tank-Mixed Herbicide Spray Solutions Containing Drift-Control Concentrate 1 or 2 and Spray Droplet Analysis:

Aqueous herbicide spray solutions containing 2% v/v of a herbicide concentrate and 0.5% v/v of Drift-control Concentrate 1 or 2 were prepared by diluting 10 mL of a herbicide concentrate (Roundup® Powermax or Durango® DMA) and 2.5 mL of the Drift-control Concentrate 1 or 2 with 487.5 mL of DI water. Three control samples containing deionized water (Control 1), 2% v/v of Roundup® Powermax (Control 2), and 2% v/v of Durango® DMA (Control 3) were also prepared. All 7 diluted spray solutions were lightly shaken by hand until each sample was homogenous.

The four herbicide spray solutions containing the paraffinic oil Sunspray® 11N and the three control samples without the paraffinic oil were sprayed using a Teejet® 8002 flat fan nozzle (Teejet Technologies; Wheaton, Ill.) at 40 psi (276 kiloPascal) and the spray droplet size distribution measurement was made with a Sympatec Helos/KF high resolution laser diffraction particle sizer with an R7 lens (Sympatec GmbH; Clausthal-Zellerfeld, Germany). The tip of the nozzle was situated 12 inches (30.5 centimeters) above the path of the laser beam of the Sympatec particle sizer. The percentage of driftable fines is expressed as the volume percentage of spray droplets below 150 microns (μm) volume mean diameter (VMD) as shown in Table 3.

TABLE 3
Spray Droplet Analysis of Herbicide Sprays with and
without a Paraffinic Oil Drift Control Adjuvant

| | | 2% v/v Herbicide Concentrate + 0.5% | |
|---|---|---|---|
| | | v/v Drift-control Concentrate | |
| Drift-control | | | Volume Percentage |
| Concentrate | Herbicide | Spray Droplet | of Driftable Fines <150 |
| 1 or 2 | Concentrate¹ | VMD, μm | μm VMD |
| none | Deionized | 168 | 44 |
| (Control 1) | water only | | |
| none | Roundup ® | 148 | 50 |
| (Control 2) | Powermax | | |
| none | Durango ® | 149 | 50 |
| (Control 3) | DMA | | |
| 1 | Roundup ® | 240 | 23 |
| | Powermax | | |
| 1 | Durango ® | 246 | 21 |
| | DMA | | |
| 2 | Roundup ® | 240 | 23 |
| | Powermax | | |
| 2 | Durango ® | 248 | 21 |
| | DMA | | |

¹Roundup ® Powermax contains 540 grams acid equivalent per liter (gae/L) of glyphosate potassium salt and is available from Monsanto (St. Louis, MO); Durango ® DMA contains 480 gae/L of glyphosate DMA salt and is available from Dow AgroSciences LLC (Indianapolis, IN).

The present invention is not limited in scope by the embodiments disclosed herein which are intended as illustrations of a few aspects of the invention and any embodiments which are functionally equivalent are within the scope of this invention. Various modifications of the compositions and methods in addition to those shown and described herein will become apparent to those skilled in the art and are intended to fall within the scope of the appended claims. Further, while only certain representative combinations of the composition components and method steps disclosed herein are specifically discussed in the embodiments above, other combinations of the composition components and method steps will become apparent to those skilled in the art and also are intended to fall within the scope of the appended claims. Thus a combination of components or method steps may be explicitly mentioned herein; however, other combinations of components and method steps are included, even though not explicitly stated. The term comprising and variations thereof as used herein is used synonymously with the term including and variations thereof and are open, non-limiting terms.

What is claimed is:

1. A method for reducing spray drift during pesticide spray application comprising:
providing a tankmix additive concentrate comprising:
from 0.5 to 50 weight percent of a surfactant, wherein the surfactant is a polymeric surfactant, a nonionic surfactant, a anionic surfactant, or mixtures thereof;
from 1 to 95 weight percent of a petroleum derived paraffinic oil.

2. The method of claim 1, further comprising adding the tankmix additive concentrate to a pesticide spray mixture, wherein the tankmix additive concentrate forms a stable emulsion upon addition to pesticide spray mixture.

3. The method of claim 2, wherein the amount of spray drift generated when spraying is decreased compared to a pesticide spray mixture sprayed without the tankmix additive concentrate.

4. The method of claim 1, wherein the petroleum derived paraffinic oil is a normal paraffin, an isoparaffin, a cycloparaffin, a highly refined paraffinic mineral oil, a solvent dewaxed light and/or a heavy paraffinic distillate, or mixtures thereof.

5. The method of claim 2, wherein the pesticide spray mixture contains a herbicide, an insecticide, a fungicide, or mixtures thereof.

6. The method of claim 5, wherein the pesticide spray mixture contains a herbicide.

7. The method of claim 6, wherein the herbicide is an auxinic herbicide.

8. The method of claim 1, wherein the anionic surfactant is an acid or salt of a mono or dialkyl phosphate ester, an acid or salt of an ethoxylated mono or dialkyl phosphate ester, an acid or salt of a mono or dialkyl phosphate ester of an ethoxylated tristyrylphenol, an acid or salt of a mono or dialkyl phosphate ester of an ethoxylated phenol or an ethoxylated alkylphenol, a salt of an alkylbenzenesulfonate, or mixtures thereof.

9. The method of claim 1, wherein the polymeric surfactant is an ABA block copolymer having a hydrophilic portion of polyethylene oxide and a hydrophobic portion of poly(12-hydroxystearate), a polyvinyl alcohol resin wherein the degree of hydrolysis is 86-89%, a block or graft acrylate or methacrylate copolymer, an alkyd polyethylene oxide resin, an AB block copolymer containing EO and PO blocks, or mixtures thereof.

10. The method of claim 1, wherein the nonionic surfactant is an alcohol alkoxylate, a fatty alcohol alkoxylate, an ethoxylated castor oil, a sorbitan ester, an ethoxylated sorbitan ester, an ethoxylated sorbitol ester, an ethoxylated tristyrylphenol, or mixtures thereof.

11. The method of claim 7, wherein the auxinic herbicide is a water soluble salt of 2,4-D, a water soluble salt of aminocyclopyrachlor, a water soluble salt of aminopyralid, a water soluble salt of clopyralid, a water soluble salt of dicamba, a water soluble salt of picloram, a water soluble salt of triclopyr, a water soluble salt of halauxifen, or mixtures thereof.

12. The method of claim 11, wherein the auxinic herbicide is a water soluble salt of 2,4-D.

13. The method of claim 12, wherein the water soluble salt of 2,4-D is 2,4-D choline salt or 2,4-D dimethyl ammonium salt.

14. The method of claim 2, wherein the pesticide spray mixture further comprises an additional herbicide.

15. The method of claim 14, wherein the additional herbicide is glyphosate or glufosinate.

16. The method of claim 14, wherein the pesticide spray mixture contains a water soluble salt of 2,4-D or a water soluble salt dicamba, and the additional herbicide is glyphosate or glufosinate.

17. The method of claim 2, wherein the pesticide spray mixture is sprayed 30 feet or more away from a sensitive or susceptible crop.

18. A tankmix additive concentrate, comprising:
from 0.5 to 50 weight percent of a surfactant; and
from 1 to 95 weight percent of a petroleum derived paraffinic oil;
wherein the tankmix additive concentrate forms a stable emulsion in a pesticide spray mixture upon addition of the tankmix additive concentrate into the pesticide spray mixture.

19. The tankmix additive concentrate of claim Error! Reference source not found, wherein the petroleum derived paraffinic oil is a normal paraffin, an isoparaffin, a cycloparaffin, a highly refined paraffinic mineral oil, a solvent dewaxed light and/or a heavy paraffinic distillate, or mixtures thereof.

20. The tankmix additive concentrate of claim 18, wherein the surfactant is at least one of a polymeric surfactant, a nonionic surfactant, and an anionic surfactant.

21. The tankmix additive concentrate of claim Error! Reference source not found, wherein the polymeric surfactant is an ABA block copolymer having a hydrophilic portion of polyethylene oxide and a hydrophobic portion of poly(l2-hydroxystearate), a polyvinyl alcohol resin wherein the degree of hydrolysis is 86-89%, a block or graft acrylate or methacrylate copolymer, an alkyd polyethylene oxide resin, an AB block copolymer containing EO and PO blocks, or mixtures thereof.

22. The tankmix additive concentrate of claim Error! Reference source not found, wherein the nonionic surfactant is an alcohol alkoxylate, a fatty alcohol alkoxylate, ethoxylated castor oils, sorbitan esters, ethoxylated sorbitan esters, ethoxylated sorbitol esters, ethoxylated tristyrylphenols, or mixtures thereof.

23. The tankmix additive concentrate of claim Error! Reference source not found, wherein the anionic surfactant is a salt of an alkylbenzenesulfonate, an acid or salt of a phosphate ester, or mixtures thereof.

24. The tankmix additive concentrate of claim Error! Reference source not found, wherein the anionic surfactant is an acid or salt of a mono or dialkyl phosphate ester, an acid or salt of an ethoxylated mono or dialkyl phosphate ester, an acid or salt of a mono or dialkyl phosphate ester of an ethoxylated tristyrylphenol, an acid or salt of a mono or dialkyl phosphate ester of an ethoxylated phenol or an ethoxylated alkylphenol, or mixtures thereof.
